(19) United States
(12) Patent Application Publication
(10) Pub. No.: US 2022/0009353 A1
(43) Pub. Date: Jan. 13, 2022

(54) SECURITY SYSTEM AND METHOD FOR OPERATING A SECURITY SYSTEM

(71) Applicant: Robert Bosch GmbH, Stuttgart (DE)

(72) Inventors: Felix Hess, Benningen (DE); Hans-Leo Ross, Lorsch (DE)

(21) Appl. No.: 17/414,566

(22) PCT Filed: Feb. 7, 2020
(86) PCT No.: PCT/EP2020/053092

§ 371 Date: Jun. 16, 2021

(30) Foreign Application Priority Data
Feb. 25, 2019 (DE) 10 2019 202 527.7

(51) Int. Cl. B60L 3/00; H04L 9/08

(52) U.S. Cl. CPC B60L 3/0092; B60L 3/0084; B60L 2260/32; H04L 9/0825; B60L 3/0038

(57) ABSTRACT

A method for operating a security system. The method includes: delivering data on at least two channels; generating information items from the data in the at least two channels; generating a verification key from the information items in the at least two channels; delivering the information items and the verification keys of the two channels to a verification device; and using the information items in defined fashion depending on the comparison of the verification keys.

### FIELD

The present invention relates to a method for operating a safety system. The present invention further relates to a safety system. The present invention further relates to a use of a safety system. The present invention further relates to a computer program product.

### BACKGROUND INFORMATION

Modern safety systems, in particular for automation systems of mobile and in particular automotive applications, require real-time-capable redundant data streams. In addition to the evaluation of video data, 3D models are continuously reconciled with the real environment in time-synchronous fashion by way of complex sensors, for instance lidar sensors, radar sensors, etc. At a speed of approximately 100 km/h, a time delay of approx. 100 ms means a deviation from reality of more than 3 m in the model. This is greater than the width of a road, and in a curve can already cause a collision with oncoming traffic.

In order to discover electronic faults and also to manage or correct those faults or to ensure a switchover to redundant functions, the aforesaid data streams must be synchronized so that a timely comparison in the data streams can take place.

In conventional synchronization one data stream is halted, and the data can be compared only when the second data flow is at the same synchronization point.

This can disadvantageously result in a considerable reduction in the speed at which these data are processed.

There are also considerable performance demands when very large data volumes are to be compared with one another in a short time; the comparison itself requires considerable time, which can appreciably reduce the performance of the overall system.

In general, a function is also a chain of sub-functions of different kinds, which produce interim results that then form the basis for further processing. If the interim results are not available in timely fashion, or if incorrect information is in fact further processed, the result can be massive system faults that, in safety-relevant systems, can cause persons to be endangered. Especially in the context of acquisition of data (e.g. by sensors), those data must be checked for correctness and timeliness before they are passed on for processing. Processing with different algorithms likewise requires time- and content-related checking before an actuator is activated using the corresponding information.

In a redundant safety system it is also important that, upon failure of one channel, the second channel can promptly take over the task of the failed channel, so that the safety function continues to be provided without interruption.

In the context of automated driving in particular, it is essential for safety-relevant functions also to be designed in fault-tolerant fashion, so that the electronic function is available even in the event of a fault. Redundancy has a dual function here, namely fault discovery and increasing the availability of the function. In the context of braking and steering systems in particular, this is a particular risk while driving, since the vehicle suddenly becomes incapable of being braked or steered.

German Patent Application No. DE 100 32 216 A1 describes a safety system in a motor vehicle, and a method in which a main computer controls and diagnoses the sensor inputs and configuration inputs.

German Patent Application No. DE 10 2008 008 555 B4 describes a method for minimizing hazardous situations in vehicles.

### SUMMARY

An object of the present invention is to furnish an improved method for operating a safety system.

In accordance with a first aspect of the present invention, the object may achieved with a method for operating a safety system. In accordance with an example embodiment of the present invention, the method includes the following steps:
delivering data on at least two channels;
generating information items from the data in the at least two channels;
generating a verification key from the information items in the at least two channels;
delivering the information items and the verification keys of the two channels to a verification device; and
using the information items in defined fashion depending on the comparison of the verification keys.

The result is to furnish a method for operating a safety system which is useful especially in real-time applications. Advantageously, with the proposed method no complex actions such as idle modes, synchronization steps, etc., such as those provided in preemptive real-time systems, are necessary. As a result, the information items can advantageously be compared at points in time other than the ones at which they were generated. The computation capacities of the two channels can thereby advantageously be optimally utilized.

According to a second aspect of the present invention, the object may achieved with a safety system. In accordance with an example embodiment of the present invention, the safety system includes:
two computer devices for independently generating information items from delivered data in at least two channels, a verification key pertinent to the information items of the at least two channels being generated therefrom; and
a verification device to which the information items of the at least two channels are deliverable,
the information items of the at least two channels being made usable in defined fashion by way of the verification device depending on the comparison.

Advantageous refinements of the method in accordance with the present invention are described herein.

An advantageous refinement of the method of the present invention provides that generation of the information items from the data, and generation of the verification keys from the information items, are carried out at defined points in time. A multi-stage method, which checks the information items at different points in time, is thereby advantageously furnished.

A further advantageous refinement of the method of the present invention provides that in the case of a fault in one channel, the information items of the other channel are used. A safety level of the safety system is thereby advantageously increased.

A further advantageous refinement of the method of the present invention provides that the verification device decides, on the basis of at least one defined criterion, which information items from which channel can be discarded. It is thereby advantageously possible to decide when information is used or is discarded as invalid.

A further advantageous refinement of the method of the present invention provides that the information items are transmitted to a vehicle by wireless communication. This advantageously supports an application in which instructions are transmitted, for instance, via WiFi (e.g. in a parking garage) to an automated vehicle.

A further advantageous refinement of the method of the present invention provides that the data are furnished by a sensor device. This makes possible applications of the method which process the sensor data in as close as possible to real time.

The present invention will be described in detail below with further features and advantages, with reference to several Figures. The Figures are intended to illustrate the main features of the present invention.

Disclosed method features are evident analogously from corresponding disclosed apparatus features, and vice versa. This means in particular that features, technical advantages, and embodiments relating to the method are evident analogously from corresponding embodiments, features, and advantages relating to the safety system, and vice versa.

### BRIEF DESCRIPTION OF THE DRAWINGS

FIG. 1 is a block diagram of a first example embodiment of a safety system of the present invention.

FIG. 2 is a block diagram of a further example embodiment of a safety system of the present invention.

FIG. 3 depicts an example method for operating a safety system in accordance with the present invention.

### DETAILED DESCRIPTION OF EXAMPLE EMBODIMENTS

The term “automated vehicle” will be used hereinafter to mean synonymously a fully automated vehicle, a partly automated vehicle, a fully autonomous vehicle, and a partly autonomous vehicle.

A main feature of example embodiments of the present invention is to furnish a monitoring architecture that ensures, in multiple levels, different time-related aspects in a redundant safety system with no reduction in the performance of the redundant system.

What may be advantageously achieved with the present invention is that the redundant data stream is directed with maximum performance through the two channels. Data contents and specific safety keys are tapped off from the system in a parallel path.

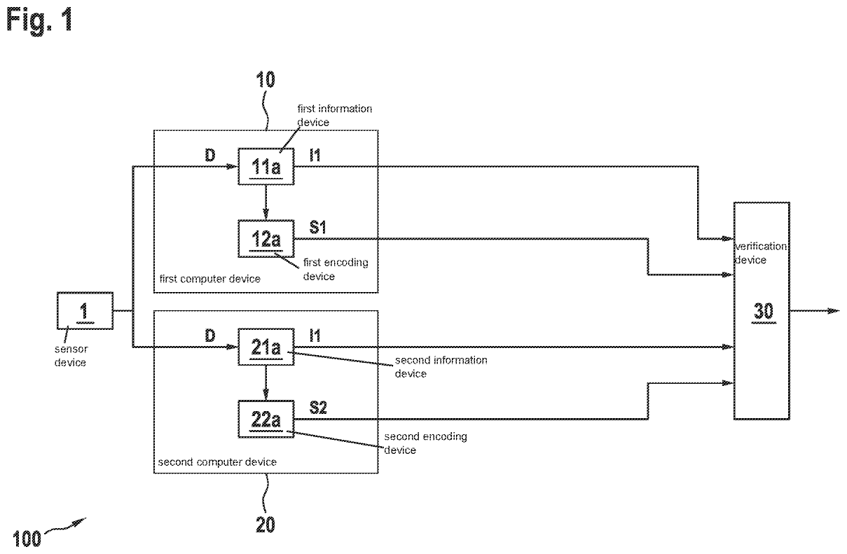

FIG. 1 is a schematic block diagram of a first example embodiment of a safety system 100 of the present invention. It shows a first computer device 10 having a first information device 11a to which data D are delivered by a sensor device 1. Information items I1 are generated from data D by way of information device 11a. Information items I1 are delivered to a first encoding device 12a, and from them said device generates a first verification key S1.

Safety system 100 furthermore has a second computer device 20 to which data D of sensor device 1 are likewise delivered. By way of a second information device 21a, information items I1 are generated from data D and are delivered to a second encoding device 22a, and from them second encoding device 22a generates a second verification key S2.

Information items I1 and verification keys S1, S2 are delivered to a verification device 30 that is preferably embodied as a safety SPS. It is thus possible for verification device 30 to compare information items I1 regardless of the point in time at which information items I1 were generated by information devices 11a, 12a, and to verify them in accordance with defined criteria, for instance for correctness and/or plausibility.

As a result, the two computer devices 10, 20, which in some circumstances can be embodied physically differently, can each use their optimum resources in order to furnish information items I1, for instance without being impeded or slowed down by idle mechanisms, synchronization mechanisms, and safety mechanisms in order to meet real-time requirements. Optimum utilization of the computing performance of the two computer devices 10, 20 is thereby advantageously supported.

Depending on the result of the comparison or the verification, verification device 30 can output an instruction in wireless or wire-based fashion to a downstream device (for example a switching device, not depicted) which contains instructions for an automated vehicle (not depicted).

The result is that with safety system 100, a redundant signal chain in two channels with time monitoring is thereby furnished.

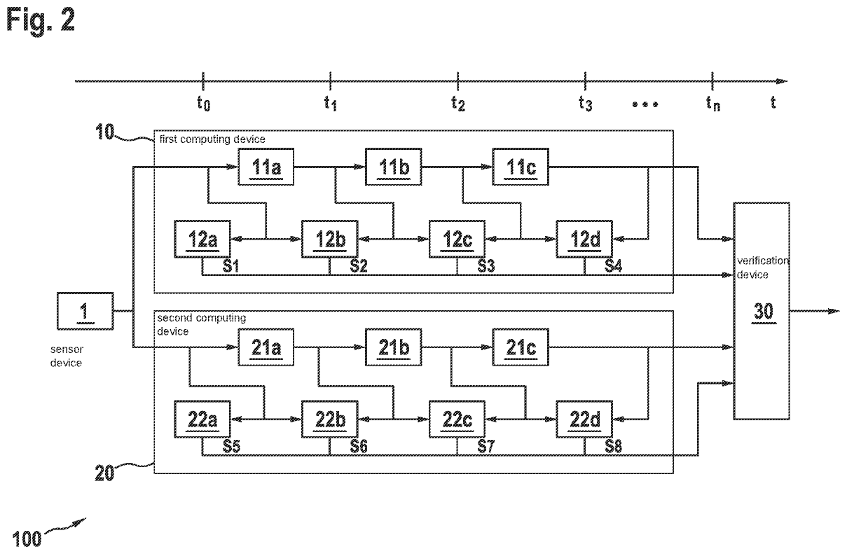

FIG. 2 is a block diagram of a second embodiment of the proposed safety system 100. It shows several points in time t0 . . . to at which information items I₁ . . . Iₙ are prepared in defined fashion from data D and at which associated verification keys S1 . . . Sn are generated from information items I₁ . . . Iₙ. Provision is made to ascertain first verification key S1 at time t₀, for instance after sensor data acquisition; to ascertain a second verification key S2 at time t₁ after a logical processing of algorithms; and to ascertain a third verification key S3 at time t₂ after a calculation of the actuator variables. The aforesaid times thus result in three time windows in which verification device 30 checks whether the respective intermediate-state data or information items have arrived, correctly in terms of content and in timely fashion, at the verification point, i.e., at verification device 30. If that is the case in each of the two redundant channels, the data stream is reported by verification device 30 to be timely and correct in terms of content.

The number of points in time shown, and the operations carried out at those points in time, are merely exemplifying, and, in practice, other, in particular substantially more, points in time can be provided at which other information items I₁ . . . Iₙ are prepared from data D and corresponding verification keys are generated. It is also possible that the data need not necessarily derive from a sensor device 1, but instead can be furnished by other devices.

Because the data streams in the two channels of safety system 100 generally have different speeds because of the different computer devices 10, 20, the information of the “monitor” in the form of verification device 30 will be available only once the redundant data stream has also reported its verification key. But because verification device 30 checks only verification keys S1 . . . Sn, the check can advantageously be carried out very quickly. As long as the check is positive, the first data stream of the first channel can always be used, for instance, for processing in the next level. The risk, however, is that verification device 30 identifies a fault, and the information in the downstream processing chain must be discarded.

It is sufficient, however, if the blockage of the faulty data stream occurs before the last functional element, which generally means application of control to the actuator (not depicted). At the actuator, however, it shuts off only the faulty data stream and not the data stream recognized as correct, so that while a possible delay occurs in the data stream, that delay refers only the time by which the second data stream trails the faulty one. In a context of homogeneous redundancy the times are generally very short.

Because the intermediate steps, for instance, after acquisition, after logic processing, and after application of control vary in terms of time, the time-related sum often exceeds the required time for the entire chain; since the worst-case situation occurs very seldom, the times in the subsidiary steps usually balance out. In terms of safety engineering, only the time between acquisition of data D in sensor device 1 and the corresponding reaction in the actuator thus needs to be measured. As long as that time for a fault-free channel is below the required time limit, the safety reaction is considered sufficient and thus “timely” in safety-engineering terms.

The aforesaid components of safety system 100 can be functionally connected to one another, for instance, via a suitable network connection (e.g., Ethernet).

An advantage of the approach in accordance with the present invention is a considerably reduced outlay in the context of synchronization of the data flow, with the result that the performance of the proposed safety system 100 achieves approximately values of a non-safety-relevant system in a single-channel implementation. Redundancy does not required a second independent software development process, since the nominal function of furnishing information from data D can be implemented identically in each of the two paths. All that is required on the other hand is implementation of corresponding monitors or encoding devices that generate the necessary verification keys S1 . . . Sn for checking the correctness of the information items at times t₀ . . . tₙ.

A further advantage of the method in accordance with an example embodiment of the present invention is that errors result in failure of only one channel, and in a context of homogeneous relevance the time delay can be considered short.

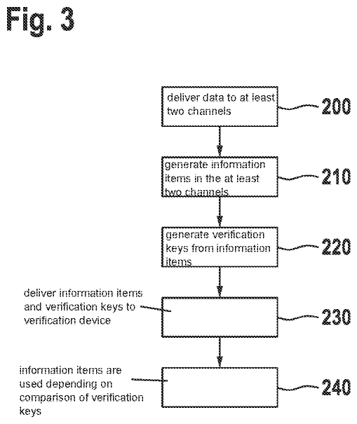

FIG. 3 schematically shows execution of an embodiment of the proposed method.

In a step 200, data D are delivered to at least two channels.

In a step 210, information items I₁ . . . Iₙ are generated from data D in the at least two channels.

In a step 220, a verification key S1 . . . Sn is generated from information items I in the at least two channels.

In a step 230, information items I₁ . . . Iₙ and verification keys S1 . . . Sn of the two channels are delivered to a verification device 30.

Lastly, in a step 240 the information items are used in defined fashion depending on the comparison of verification keys S1 . . . Sn.

Advantageously, the proposed method can be used in a safety system in a context of automated parking and/or in urban surroundings.

The example method can advantageously be realized in the form of a software program having suitable program code means, which executes on safety system 100 with its components. Simple adaptability of the method is thereby possible.

One skilled in the art will modify the features of the present invention, and/or combine them with one another in suitable fashion, without deviating from the scope of the present invention. Provision can be made, for example, for the number of channels of the safety system also to be greater than two.

1-9. (canceled)

10. A method for operating a safety system, comprising the following steps:
delivering data on at least two channels;
generating information items from the data in each of the at least two channels;
generating a verification key from the information items in each of the at least two channels;
delivering the information items and the verification keys of the at least two channels to a verification device; and
using the information items in defined fashion depending on a comparison of the verification keys.

11. The method as recited in claim 10, wherein the generation of the information items from the data, and the generation of the verification keys from the information items, are carried out at defined points in time.

12. The method as recited in claim 10, wherein in the case of a fault in one of the at least two channels, the information items of the other channel are used.

13. The method as recited in claim 10, wherein the verification device decides, based on at least one defined criterion, which information items from which channel of the at least two channels can be discarded.

14. The method as recited in claim 10, wherein the information items are transmitted to a vehicle by wireless communication.

15. The method as recited in claim 10, wherein the data are furnished by a sensor device.

16. The method as recited in claim 10, wherein the method is used in a context of automated parking and/or in urban surroundings.

17. A safety system, comprising:
two computer devices which independently generate information items from delivered data in at least two channels, a verification key pertinent to the information items of the at least two channels being generated from the information items; and
a verification device to which the information items of the at least two channels are deliverable, the information items of the at least two channels being made usable in defined fashion using the verification device depending on a comparison.

18. A non-transitory computer-readable data medium on which is stored program code configured to operate a safety system, the program code, when executed by the safety system, causing the safety system to perform the following steps:
delivering data on at least two channels;
generating information items from the data in each of the at least two channels;
generating a verification key from the information items in each of the at least two channels;
delivering the information items and the verification keys of the at least two channels to a verification device; and
using the information items in defined fashion depending on a comparison of the verification keys.
